(19) United States
(12) Patent Application Publication
(10) Pub. No.: US 2015/0192497 A1
(43) Pub. Date: Jul. 9, 2015

(54) SYSTEM AND METHOD FOR DETECTING FAULT IN IGNITION SYSTEM

(71) Applicant: Caterpillar Inc., Peoria, IL (US)

(72) Inventors: Brandon Gregory, Peoria, IL (US); Francis L. Clark, III, Pekin, IL (US); James Cress, West Lafayette, IN (US)

(73) Assignee: Caterpillar Inc., Peoria, IL (US)

(21) Appl. No.: 14/149,860

(22) Filed: Jan. 8, 2014

(51) Int. Cl. G01M 15/11; G01M 15/08

(52) U.S. Cl. CPC G01M 15/11; G01M 15/08

(57) ABSTRACT

An on-board diagnostic system for detecting a fault in an ignition system of an engine system having a cylinder is provided. The system includes an indicated mean effective pressure (IMEP) monitoring module for monitoring IMEP indicating average pressure in the cylinder during an operation cycle of the cylinder for an engine runtime. A misfire detection module detects misfire cycles associated with the cylinder based on the monitored IMEP. An ignition system diagnostic module communicatively coupled to the misfire detection module includes a statistical module and a control module. The statistical module determines a percentage of the misfire cycles during the engine runtime. The control module changes an operational parameter of the engine system when the percentage of the misfire cycles is less than a pre-defined threshold value or provides a warning message for required maintenance when the percentage of the misfire cycles is greater than the pre-defined threshold value.

### TECHNICAL FIELD

The present disclosure relates to an On-board diagnostic system for an internal combustion engine, and more particularly to the On-board diagnostic system and a method for detecting a fault in an ignition system of the internal combustion engine.

### BACKGROUND

One of the most commonly known engine problem is engine combustion failure, known as misfire cycles. On-board diagnostic (OBD) systems are used to detect such misfires in each of the cylinders in the engine by determining an indicated mean effective pressure (IMEP) for combustion cycles within engine cylinders. IMEP is an average pressure produced in a combustion chamber during an operation cycle in the engine.

U.S. Pat. No. 6,415,656 relates to a misfire monitoring method and system that employ an indicated mean effective pressure (IMEP) parameter for misfire monitoring of an internal combustion engine of a vehicle.

### SUMMARY

In an aspect of the present disclosure, an on-board diagnostic system for detecting a fault in an ignition system of an engine system having a cylinder is disclosed. The on board diagnostic system includes an indicated mean effective pressure (IMEP) monitoring module configured to monitor an indicated mean effective pressure (IMEP) indicative of an average pressure in the cylinder during an operation cycle of the cylinder during an engine runtime. Further, the on board diagnostic module includes a misfire detection module configured to detect misfire cycles associated with the cylinder based on the monitored IMEP during the engine runtime. An ignition system diagnostic module is communicatively coupled to the misfire detection module. The ignition system diagnostic module includes a statistical module and a control module operatively connected to the statistical module. The statistical module is configured to determine a percentage of the misfire cycles during the engine runtime. The control module is configured to perform at least one of changing an operational parameter of the engine system when the percentage of the misfire cycles is less than a pre-defined threshold value and providing a warning message indicating a required maintenance when the percentage of the misfire cycles is greater than the pre-defined threshold value.

In another aspect of the present disclosure, a method for detecting a fault in an ignition system of an engine system is provided. The engine system includes a cylinder. The method includes monitoring an indicated mean effective pressure (IMEP) indicative of an average pressure in the cylinder during an operation cycle of the cylinder during an engine runtime. Misfire cycles associated with the cylinder are detected based on the monitored IMEP during the engine runtime. The percentage of misfire cycles is compared with a pre-defined threshold value. An operational parameter of the engine system is changed when the percentage of the misfire cycles is less than the pre-defined threshold value. A warning message is provided. The warning message is indicative of a required maintenance when the percentage of the misfire cycles is greater than the pre-defined threshold value.

In a yet another aspect of the present disclosure, an engine system is provided. The engine system includes a cylinder defining a combustion chamber and an ignition system for igniting an air-fuel mixture in the combustion chamber. Further, the engine system includes an on-board diagnostic system for detecting a fault in an ignition system. The on board diagnostic system includes an indicated mean effective pressure (IMEP) monitoring module configured to monitor an indicated mean effective pressure (IMEP) indicative of an average pressure in the cylinder during an operation cycle of the cylinder during an engine runtime. Further, the on board diagnostic module includes a misfire detection module configured to detect misfire cycles associated with the cylinder based on the monitored IMEP during the engine runtime. An ignition system diagnostic module is communicatively coupled to the misfire detection module. The ignition system diagnostic module includes a statistical module and a control module operatively connected to the statistical module. The statistical module is configured to determine a percentage of the misfire cycles during the engine runtime. The control module is configured to perform at least one of changing an operational parameter of the engine system when the percentage of the misfire cycles is less than a pre-defined threshold value and providing a warning message indicating a required maintenance when the percentage of the misfire cycles is greater than the pre-defined threshold value.

Other features and aspects of this disclosure will be apparent from the following description and the accompanying drawings.

### BRIEF DESCRIPTION OF THE DRAWINGS

FIG. 1 illustrates a schematic representation of an internal combustion engine;

FIG. 2 illustrates a graph showing misfire situations in one of a cylinder of the internal combustion engine of FIG. 1;

FIG. 3 illustrates a block diagram of an on-board diagnostic system for detecting ignition system failure, according to an embodiment of the present disclosure; and

FIG. 4 illustrates an exemplary method for detecting failure of the ignition system of the engine, according to an embodiment of the present disclosure.

### DETAILED DESCRIPTION

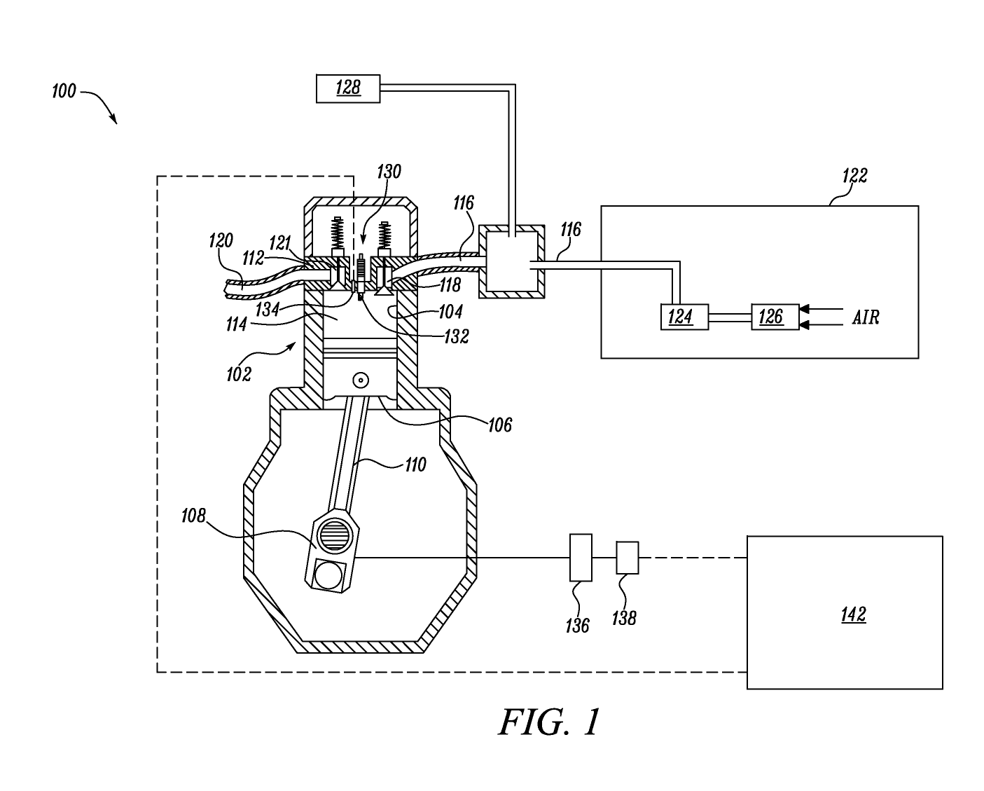

The present disclosure relates to a system and method for detecting ignition system fault and/or failure in an internal combustion engine. The present disclosure will now be described in detail with reference being made to accompanying figures. FIG. 1 illustrates a schematic representation of an engine system 100, according to an embodiment of the present disclosure. Various embodiments described herein have been explained for a spark-ignited engine, such as a gasoline engine or a natural gas engine. However, it may be contemplated that the described embodiments may be implemented with any type of spark-ignited engine such as a hybrid fuel engine, or an engine using gaseous fuels like propane, or methane.

The engine system 100 includes an engine 102 having a cylinder 104 made of metallic alloys such as steel, aluminum based alloys, etc. It is contemplated that the engine 102 may include any number of cylinders 104 and that the cylinders 104 may be disposed in an “in-line” configuration, a “V” configuration, or any other conventional configuration. The engine 100 may be used to power any machine or other device, including on-highway trucks or vehicles, off-highway trucks or machines, earth moving equipment, generators, aerospace applications, locomotive applications, marine applications, pumps, stationary equipment, and other engine powered applications.

Each of the cylinders 104 include a piston 106 adapted to reciprocate therein. The piston 106 is connected to a crankshaft 108 via a connecting rod 110. The piston 106 may be configured to reciprocate between a bottom-dead-center (BDC) position, or lower-most position within the cylinder 104, and a top-dead-center (TDC) position, or upper-most position within the cylinder 104.

Furthermore, a cylinder head 112 may be associated with the cylinder 104 and may together define a combustion chamber 114. An intake passage 116 may fluidically connect and lead to an intake valve 118 of the cylinder 104 and configured to supply air-fuel mixture into the combustion chamber 114. Furthermore, an exhaust passage 120 may fluidically connect and lead from an exhaust port 121 of the cylinder 104. The exhaust passage 120 may be configured to convey a number of combustion by-products out of the combustion chamber 114. It may be contemplated that the cylinder head 112 may alternatively be associated with the single cylinder 104 or multiple cylinders 104 as per design and application of the engine system 100.

The engine system 100 may further include an air supply unit 122 to supply air into the combustion chamber 114. The air supply unit 120 may include an intake manifold 124 fluidically connected with the intake passage 116 and a fan 126. The fan 126 is configured to draw atmospheric air via an air inlet and provide air into the combustion chamber 114 via the intake manifold 124 and the intake passage 116. It may be contemplated that the air supply unit 122 may also include additional air handling components such as, a waste gate valve, a throttle valve, an EGR system, an air cleaner, an air cooler, or any other air handling components known in the art.

A fuel tank 128 may be provided in the engine system 100 and configured to supply pressurized fuel into the combustion chamber 114 of the engine 102 through the intake valve 118. The fuel tank 128 may be configured to produce a flow of pressurized fluid and may include a pump such as, for example, a variable displacement pump, a fixed displacement pump, a variable flow pump, or any other source of pressurized fluid known in the art. The fuel tank 128 may be drivably connected to a power source (not shown) by, for example, a countershaft (not shown), a belt (not shown), an electrical circuit (not shown), or in any other suitable manner It is also contemplated that the fuel tank 128 may alternatively be a supply of pressurized gaseous fuel.

The engine system 100 may further include an ignition system 130 used for igniting the air-fuel mixture in the combustion chamber 114. The ignition system 130 may include a spark plug 132 disposed within the cylinder head 112 for introducing a spark into the combustion chamber 114 for combusting the air-fuel mixture. The ignition system 130 is configured to ignite the fuel at an optimum time to produce maximum power. If the ignition system fires at a wrong time, the power produced may decrease, whereas fuel consumption and exhaust emissions may increase. Therefore, timing of the ignition system 130 plays a very critical role in the engine's performance. It may be contemplated, that the spark plug 132 may further include an ignition coil (not shown) configured to create an electric spark in the spark plug 132 to ignite the fuel within the combustion chamber 114.

In an exemplary embodiment, the engine system 100 includes an In-cylinder pressure sensor 134, hereinafter referred to as the pressure sensor 134, configured to measure pressure in the combustion chamber 114 during an operation cycle of the cylinder 104. In an embodiment, the pressure sensor 134 may be a piezoelectric type pressure sensor that harnesses certain crystal property of yielding electrical charge when placed under mechanical stress. The pressure sensor 134 may be disposed within the cylinder head 112 adjacent to the spark plug 132.

In an exemplary embodiment, the engine system 100 further includes a crank angle sensor 136 associated with the crankshaft 108 and configured to determine a crank angle CA of the crankshaft 108 to determine a position of the piston 106. Furthermore, an angle encoder 138 is provided in association with the crank angle sensor 136 and configured to convert an analog parameter crank angle CA into digital electronic signals. As may be understood by a person having ordinary skill in the art that the crank angle CA may be measured with respect to the position of the crankshaft 108 when the piston 106 reaches the TDC within the cylinder 104. Therefore, the crank angle CA when the piston reaches TDC would be 0 degrees, and similarly, for 0 degrees crank angle CA, the position of the piston 106 may be at the TDC.

In an embodiment, an on-board diagnostic (OBD) system 142, hereinafter referred to as the OBD system 142, is provided within the engine system 100. The OBD system 142 is associated with the cylinder 104 of the engine system 100. Although only one cylinder 104 and one OBD system 142 is described herein, it may be well understood by a person having ordinary skill in the art, that there may be more than one OBD systems 142, where each cylinder 104 having its own OBD system 142.

In an embodiment, the OBD system 142 is configured to calculate an Indicated mean effective pressure (IMEP) for the cylinder 104 by using the monitored in-cylinder pressure from the pressure sensor 134 and the crank angle CA from the crank angle sensor 136 and the angle encoder 138. Generally, the IMEP of a cylinder 104 is indicative of an average pressure during each operation cycle of the cylinder during a pre-defined engine runtime.

The OBD system 142 is configured to further utilize the IMEP to detect a misfire cycle in the cylinder 104 continuously during an entire running time of the engine 102. The misfire cycle may be defined as an incomplete combustion of the air-fuel mixture during the operation cycle of the cylinder 104. Generally, misfires may be generated or caused by a change in one or more operational parameters associated with the engine system 100. Examples of change in the various operational parameters may include change in a intake temperature of the fuel provided into the combustion chamber 114, so that the temperature of the fuel is not sufficient to completely burn the fuel, or change in a fuel-air equivalence ratio, such as by providing ultra lean air-fuel mixture to the combustion chamber 114 and/or changing an amount of fuel supplied to the combustion chamber, such as completely shutting down the fuel supply to the combustion chamber 114. As will be understood by a person having ordinarily skill in the art, that the fuel-air equivalence ratio is the ratio of the supplied air-fuel ratio to the combustion chamber 114 with respect to a stoichiometric air-fuel ratio ideal for the engine system 100. Furthermore, misfires may be a result of the failure of the ignition system 130 or may be done intentionally by changing the spark timing by the spark plug 132 or by changing the fuel injection timing

Generally, in-cylinder pressure of the combustion chamber 114 increases during a compression stroke in the combustion cycle. When a spark is introduced into the combustion chamber 114, the pressure in the combustion chamber 114 further rises at a steep rate before decreasing in an exhaust stroke of the combustion cycle. This variation in the in-cylinder pressure is used by the OBD along with other engine parameters to determine the IMEP for the corresponding cylinder 104. Certain engine parameters used for determining the IMEP may include, engine torque, engine displacement, crank angle, etc. Subsequently, the IMEP is used to detect the misfire situations, as during the misfire situations, the IMEP for that operation cycle of the cylinder 104 goes down to a negative value, i.e., below zero level.

According to an embodiment of the present disclosure, the OBD system 142 is configured to monitor a percentage of misfire cycles in the cylinder 104 during an engine runtime based on the IMEP and detect a possible fault and/or failure in the ignition system 130. As explained previously, the ignition system 130 includes the spark plug 132, the electrical coil, and an extender. Therefore, the ignition system 130 faults and/or failure may be caused and damage any of the above components of the ignition system 130. In general, most of the ignition system 130 failure and/or faults are caused due to a fault in the spark plug 132, and may be corrected by correcting or replacing the spark plug 132. However, sometimes the ignition system 130 faults and/or failure may be caused by a fault in the coil and/or the extender of the ignition system 130 and may be corrected by replacing the respective component of the ignition system 130. Moreover, based on a detection of the fault/failure of the ignition system 130, the OBD system 142 may further be configured to inform an operator of the machine in case maintenance is to be scheduled for the ignition system 130.

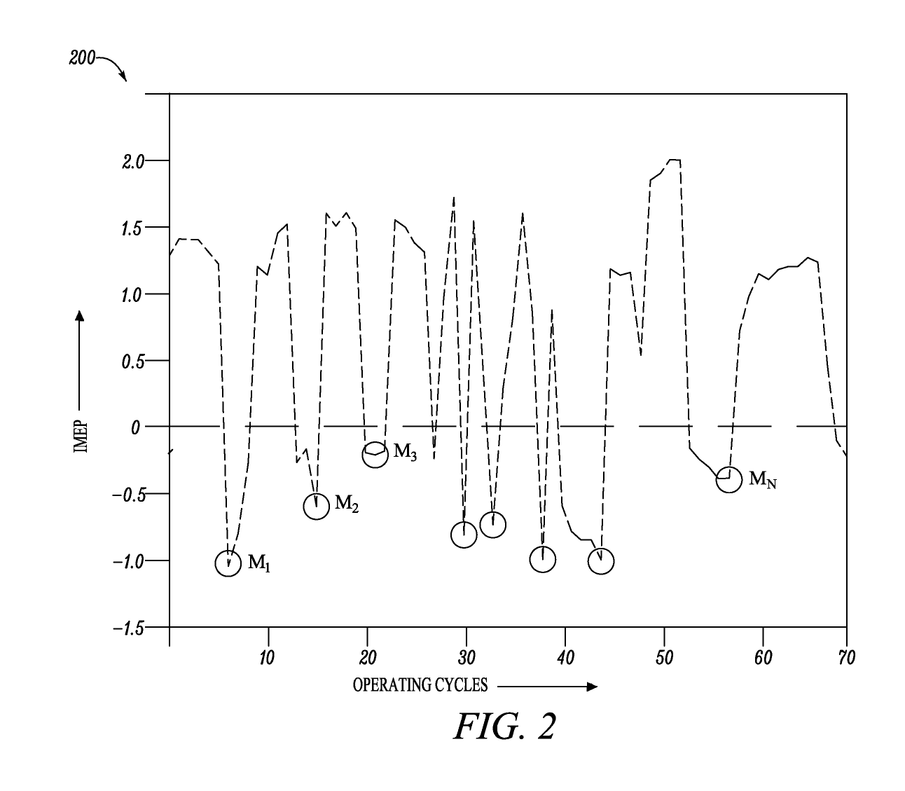

FIG. 2 illustrates an exemplary graph 200 showing the misfire cycles among a number of the operation cycles of the cylinder 104 during the engine runtime. According to the illustrated embodiments, the engine runtime may include one hundred (100) operation cycles of the cylinder 104, then the IMEP for each of the operation cycles of the cylinder 104 is monitored to identify the misfire cycles (M₁, M₂, M₃ . . . M_{N}) of the cylinder 104. The graph 200 includes the IMEP plotted along the vertical axis against the operation cycles of the cylinder 104 along the horizontal-axis. During the engine runtime, the IMEP may vary for each of the operation cycle of the cylinder 104. In general, during each of the misfire cycle (M₁, M₂, M₃ . . . M_{N}) the IMEP for that operation cycle of the cylinder is also decreased considerably below a reference marking. For example, the IMEP monitored below a pre-defined reference marking in FIG. 2 may be indicative of discreet points corresponding to the misfire cycles (M₁, M₂, M₃ . . . . M_{N}) of the cylinder 104. In an exemplary embodiment, the pre-defined reference marking may be based on an average IMEP value of all the cylinders 104 in the engine 102.

In an alternative embodiment, the OBD system 142 may determine heat release rate associated with the cylinder 104 to identify the misfire cycles. The heat release rate is an amount of heat released per unit volume of fuel burnt in the combustion chamber 114 for a single operation cycle of the cylinder 104. Similar to the IMEP, the heat release rate for misfire cycle is decreased. For example, if the heat release rate for an operation cycle of the cylinder 104 is less than a predetermined threshold value, then that operation cycle is identified as the misfire cycle. In an exemplary embodiment, the misfire cycles (M₁, M₂, M₃ . . . M_{N}) may be identified by using at least one of or a combination of the monitored IMEP and the heat release rate.

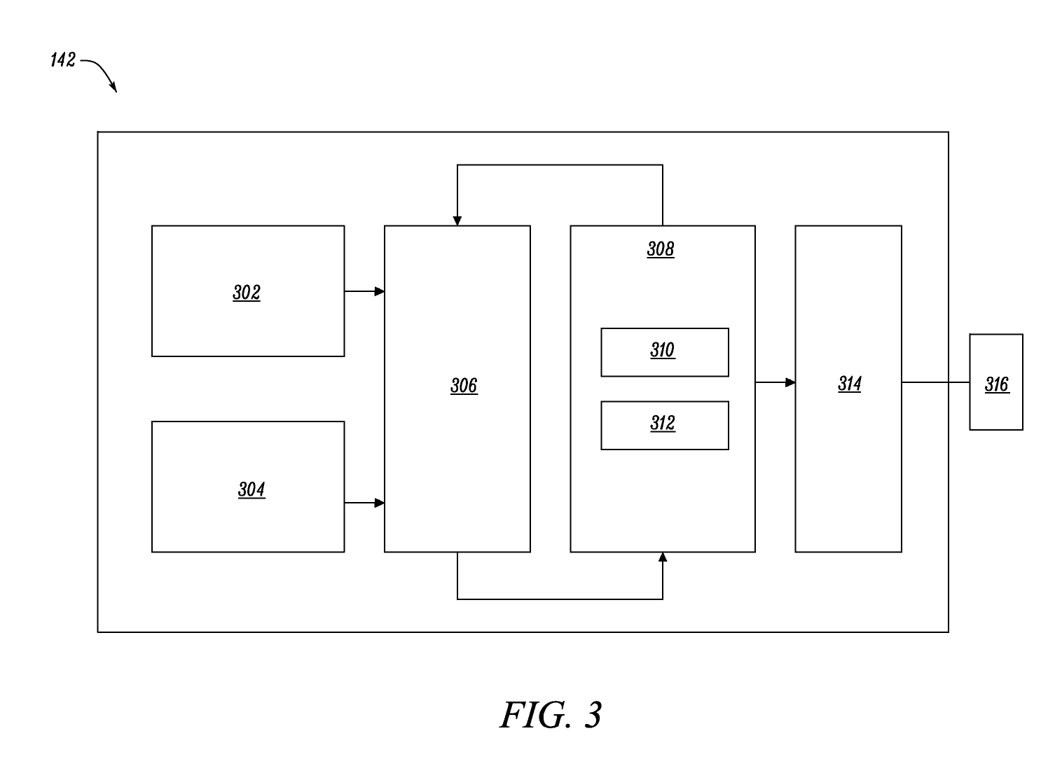

FIG. 3 illustrates a block diagram of the on-board diagnostic (OBD) system 142 associated the engine system 100. The OBD system 142 includes an IMEP monitoring module 302, and a heat release rate monitoring module 302 configured to calculate and monitor the IMEP and the heat release rate for every operation cycle of the cylinder 104, respectively. As explained with reference to FIGS. 1 and 2, the IMEP monitoring module 302 is configured to receive input signals from the pressure sensor 134 and the angle encoder 138 indicative of the determined in-cylinder pressure and the crank angle CA respectively. The IMEP monitoring module 302 calculates the IMEP for every operation cycle of the cylinder 104 based on the received in-cylinder pressure and the crank angle CA using methods well known in the art. In addition to the in-cylinder pressure and the crank angle, the IMEP monitoring module 302 may use displaced cylinder volume and engine torque output values to calculate the IMEP for the operation cycle of the cylinder 104.

Furthermore, the heat release rate monitoring module 304 is configured to receive input signals from the pressure sensor 134 and the angle encoder 138 indicative of the determined in-cylinder pressure and the crank angle CA respectively. The heat release rate monitoring module 304 calculates the heat release rate for every operation cycle of the cylinder 104 based on the received in-cylinder pressure and the crank angle CA using methods well known in the art. Further, in addition to the in-cylinder pressure and the crank angle, the heat release rate may also be based on a cylinder volume.

The OBD system 142 further includes a misfire detection module 306 configured to detect misfire cycles for a continuous runtime of the engine 102 operations. In an embodiment, the misfire detection module 306 receives the IMEP and/or the heat release rate from the IMEP monitoring module 302 and the heat release rate monitoring module 304, respectively, to detect a first set of misfire cycles of the cylinder 104 during the engine runtime.

According to an embodiment of the present disclosure, the OBD system 142 includes an ignition system diagnostic module 308 having a statistical module 310 and a control module 312. The ignition system diagnostic module 308 is configured to detect a possible fault and/or failure of the ignition system 130 and change the one or more operational parameters of the engine system 100 to rectify the fault and/or indicate to the operator of the machine that the fault and/or the failure of the ignition system 130 is severe and a maintenance is required to be scheduled to rectify the fault. It may be contemplated that the control module 312 may include any appropriate type of a general purpose computer, special purpose computer, microprocessor, microcontroller, or other programmable data processing apparatus. In an aspect of the present disclosure, the control module 312 may be machine engine control module (ECM).

When a misfire cycle is detected by the misfire detection module 306, the misfire detection module 306 communicates with the statistical module 310 to store the detected misfire cycles out of the total number of operation cycles of the cylinder 104 during the engine runtime. The statistical module 310 is configured to determine if the misfires in the first set of misfires are intermittent. If the statistical module 310 determines that the misfires are intermittent, then the statistical module 310 is configured to monitor the misfire cycles in the first set of misfire cycles for a statistical analysis. In an exemplary embodiment, the statistical module 310 is configured to determine a first percentage of misfire cycles within the total number of operation cycles performed by the cylinder 104 during the engine runtime. For example, if there are 100 operation cycles of the cylinder 104 during the engine runtime, and about 15 of the operation cycles are misfire cycles, then the first percentage of misfire cycles is equal to about 15%.

The statistical module 310 is further configured to compare the determined first percentage of misfire cycles with a first pre-define threshold value P1. If the first percentage of misfire cycles is greater than P1, then the statistical module 310 is configured to communicate with the control module 312 to send a signal indicating a possible improper functioning of the ignition system 130. In an exemplary embodiment, the first pre-defined threshold value P1 may be predefined based on a limit of sustainability of the engine 102 for the misfires. Therefore, upto P1 percentage of misfire cycles, the engine 102 may sustain the misfires, and that such percentage of misfire cycles may be corrected by changing the one or more operational parameters of the engine system 100.

The control module 312 is further configured to change the one or more operational parameters of the engine system 100 to determine if there is a change in the misfire cycles for the cylinder 104. In an embodiment, the control module 312 is configured to change the operational parameters by lowering the temperature of the fuel provided to the combustion chamber 114, and/or changing an ignition timing, and/or by reducing the amount of fuel supplied to the combustion chamber 114, etc., to determine if there is a change in the percentage of the misfire cycles, and/or reduction in the percentage of the misfire cycles.

In an exemplary embodiment, when the control module 312 changes the one or more operational parameters of the engine system 100, then the operation cycles of the cylinder 104 are again monitored by the misfire detection module 308 to detect a second set of misfire cycles in a similar manner as explained previously. As will be understood by a person having ordinary skill in the art that the misfire detection module 308 and the ignition system diagnostic module 310 may be communicating with each other continuously during the engine runtime.

In an embodiment, the detected second set of misfire cycles is provided to the statistical module 310 to determine a second percentage of misfire cycles within the total number operation cycles of the cylinder 104 after the operational parameters are changed. The second percentage of misfire cycles is compared with the first percentage of misfire cycles to check if the percentage of misfire cycles has reduced. In an exemplary embodiment, if the statistical module 310 determines that the second percentage of misfire cycles is lower than the first percentage of misfire cycles, then the statistical module 310 is configured to detect that there is no ignition system failure and/or fault in the ignition system 130. The operation of the OBD system 142 may continue for the further operation cycles of the cylinder 104.

However, if the statistical module 310 determines that the second percentage of misfire cycles is not less than the first percentage of misfire cycles, and/or if the second percentage of misfire cycles is greater or equal to the first percentage of misfire cycles, then the statistical module 310 is configured to perform a further analysis of the second set of misfire cycles.

In an embodiment of the present disclosure, the statistical module 310 is configured to further compare second percentage of misfire cycles with a second pre-defined threshold value P2. The second pre-defined threshold value P2 may be indicative of a possible fault or failure of the ignition system 130. In an embodiment, the second pre-defined threshold value P2 is greater than the first pre-defined threshold value P1. When the statistical module 310 determines that the second percentage of misfire cycles is lesser than P2, then the statistical module 310 may indicate to the control module 312 that the misfires are still sustainable and may be corrected by changing the one or more operational parameters of the engine system 100 in a similar manner as explained previously.

However, if the second percentage of misfire cycles is greater than P2, then the statistical module 310 is configured to detect that a possible ignition system 130 failure or fault has occurred and that a rigid action to correct the fault is required. In an embodiment, the ignition system diagnostic module 308 is configured to send a warning signal to the operator of the machine via an operator warning system 314. For example, the operator warning system 314 may be operatively connected to an output device 316 provided on a control panel within an operator station of the machine. Examples of the output device 316 may include a display device, an audio device etc. In an exemplary embodiment, the warning message sent to the operator may indicate that a maintenance is to be scheduled to get the ignition system 130 checked.

It may be contemplated that during the maintenance, the fault and/or failure of the ignition system 130 may be rectified by replacement of a corresponding component of the ignition system 130.

### INDUSTRIAL APPLICABILITY

The industrial applicability of the ignition system diagnostic module 308 within the on-board diagnostic system (OBD) 142 for the engine system 100 of the machine will be readily understood from the foregoing discussion.

Conventionally, OBD systems have been known for detecting misfire cycles for a cylinder of an engine. However, using these misfire detection techniques for detecting larger problems in the engine or the ignition system of the engine has not been known. Therefore, not knowing the underlying problem behind the misfires may lead to causing damage to the engine system and may cause hazards for the operator of the machine.

According to an embodiment of the present disclosure, the OBD system 142 receives the in-cylinder pressure and the crank angle CA to determine the IMEP and/or the heat release rate of the cylinder 104. Further, the OBD system 142 identifies the misfire cycles among the total number of operation cycles performed by the cylinder 104 during the engine runtime. The ignition system diagnostic module 308 is configured to perform a statistical measure on the identified misfire cycles to detect a possible ignition system 130 fault and/or failure. Once the OBD system 142 identifies the fault and/or failure in the ignition system 130, maintenance can be scheduled and the problem associated with the ignition system 130 may be rectified. The OBD system 142 and the ignition system diagnostic module 308 may provide a compact, cost effective and easy to implement system for identifying ignition system faults and failure so that they can be timely rectified without causing any damage to the engine system 100 and the machine.

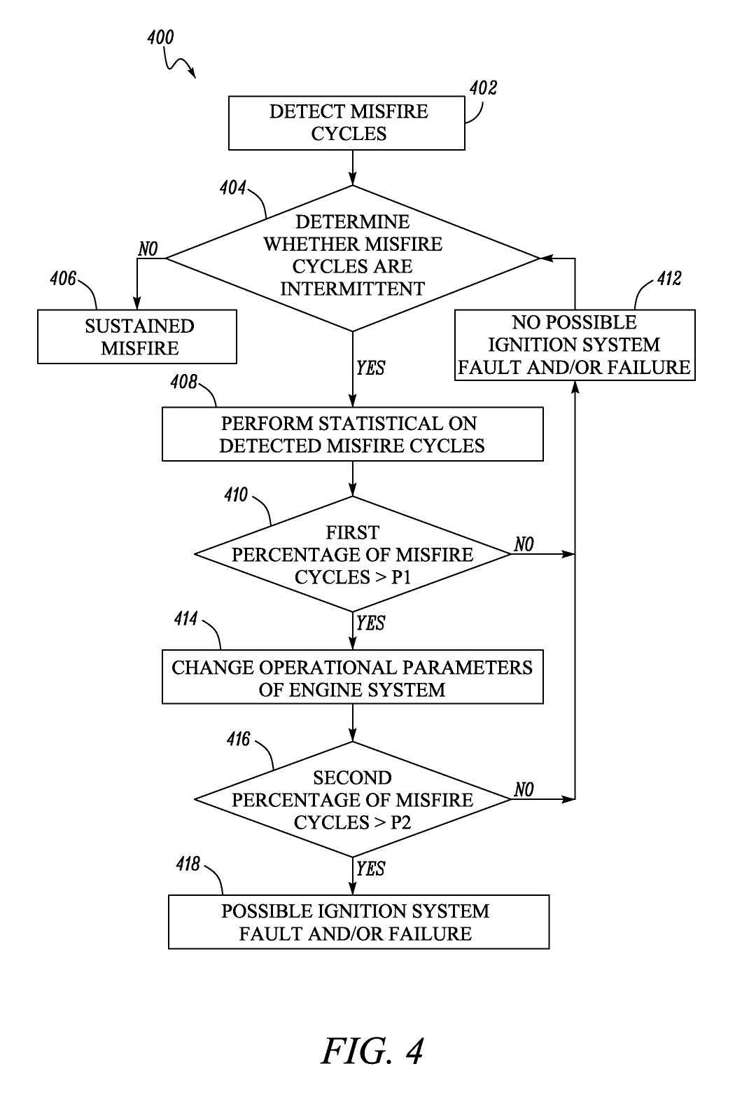

FIG. 4 illustrates an exemplary method 400 performed by the OBD system 142 for detecting ignition system 130 faults and failures. Firstly, at step 402, misfire cycles are detected. A misfire cycle may be defined as an incomplete combustion of the air-fuel mixture during the operation cycle of the cylinder 104. During the engine runtime, runtime, using the IMEP for a specific operation cycle of the cylinder 104 may identify the misfire cycles for the cylinder 104. In an alternative embodiment, heat release rate may also be used to detect misfire cycles of the cylinder 104. The IMEP monitoring module 302 calculates the IMEP and heat release rate monitoring module 304 calculates the heat release rate. The IMEP and/or the heat release rate is calculated based on the in-cylinder pressure from the pressure sensor 134 and the crank angle CA from the angle encoder 138.

Further, at step 404, it is determined whether the misfire cycles are intermittent. In case the misfire cycles are not intermittent, i.e., the NO path from the block 404, then the control moves to block 406. At step 406, the misfire cycles are determined to be sustained misfires which may be undesirable for the engine 102 as they may result in an imbalance in load of the engine 102 which may be outside a desired operating range of the engine 102. However, in case at step 404, it is determined that the misfire cycles are intermittent, i.e., YES path from the block 404, then the control moves to block 408. For the engine runtime, the misfire cycles detected for the cylinder 104 may be stored as the first set of misfire cycles.

At step 408, a statistical analysis of the first set of misfire cycles is performed. In an embodiment, after completing the engine runtime, the misfire cycles are identified for the cylinder 104. Further, the first percentage of misfire cycles within the total number of operation cycles of the cylinder 104 is determined.

The determined first percentage of misfire cycles is compared with the first pre-defined threshold value P1 at step 410. If the first percentage of misfire cycles is lesser than P1, i.e., the NO path from step 410, then the control moves to step 412 where it is detected that there is no possible ignition system 130 failure. For example, the first pre-defined threshold value P1 may be predefined based on the limit of sustainability of the engine 102 for the misfires. This means that upto P1 percentage of misfire cycles, the engine 102 may sustain the misfire cycles, and that such percentage of misfire cycles may be corrected by changing the operational parameters associated with the engine system 100.

Further, if at step 410 it is determined that the first percentage of misfire cycles is greater than P1, i.e., the YES path from step 410, then the control moves to step 414. At step 414, a number of operational parameters associated with the engine system are changed. In an embodiment, the control module 312 may facilitate changing of the operational parameters of the engine system 100, for example, lower the temperature of the fuel provided to the combustion chamber 114, and/or change a timing of the spark ignited by the ignition system 130, and/or reduce the amount of fuel supplied to the combustion chamber 114, etc., to determine if there is a change in the misfire cycles, and/or reduction in the percentage of the misfire cycles. When the one or more operational parameters are changed by the control module 312, then the operation cycles of the cylinder 104 are again monitored to detect a second set of misfire cycles in a similar manner as explained previously.

Furthermore, a second percentage of misfire cycles within the total number operation cycles performed by the cylinder 104 is determined The second percentage of misfire cycles is compared with the first percentage of misfire cycles to check if the percentage of misfire cycles has reduced. In an exemplary embodiment, if it is determined that the second percentage of misfire cycles is lower than the first percentage of misfire cycles, then it is determined that there is no ignition system failure and/or fault in the ignition system 130. However, if it is determined that the second percentage of misfire cycles is not less than the first percentage of misfire cycles, and/or if the second percentage of misfire cycles is greater than the first percentage of misfire cycles, then the control moves to step 416.

At step 416, the second percentage of misfire cycles is compared with the second pre-defined threshold value P2. The second pre-defined threshold value P2 may be greater than the sustainable limit of the engine system 100 and may be indicative of a possible fault or failure of the ignition system 130. In an embodiment, the second pre-defined threshold value P2 is greater than the first pre-defined threshold value P1. If at step 416, it is determined that the second percentage of misfire cycles is less than P2, i.e., the NO path from step 416, then the control moves to step 412. At step 412, it is concluded that there is no possible ignition system fault and/or failure.

However, if at step 416, it is determined that the second percentage of misfire cycles is greater than P2, i.e., the YES path from step 416 then the control moves to step 418. At step 418, a possible ignition system 130 failure or fault is detected and a warning signal is provided to the operator of the machine to schedule maintenance. In an embodiment, the ignition system diagnostic module 308 is configured to send a warning signal to the operator of the machine via an operator warning system 314. For example, the operator warning system 314 may be operatively connected to a control panel of the machine, such that the warning message is provided to the operator by using either a display device, or an audio device etc., in the control panel of the machine.

During the maintenance, it is detected if there is a fault in the ignition system 130 or if the ignition system 130 has encountered a failure. It may be contemplated that the ignition system 130 fault and/or failure may be caused by any of the components of the ignition system 130. In general, most of the ignition system 130 failure and/or faults are caused due to a fault in the spark plug 132, and may be corrected by correcting or replacing the spark plug 132. However, sometimes the ignition system 130 faults and/or failure may be caused by a fault in the coil and/or the extender of the ignition system 130 and may be corrected by replacing the respective component of the ignition system 130.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. An on-board diagnostic system for detecting a fault in an ignition system of an engine system having a cylinder, the on-board diagnostic system comprising:
an indicated mean effective pressure (IMEP) monitoring module configured to monitor an indicated mean effective pressure (IMEP) indicative of an average pressure in the cylinder during an operation cycle of the cylinder for an engine runtime;
a misfire detection module configured to detect misfire cycles associated with the cylinder based on the monitored IMEP during the engine runtime; and
an ignition system diagnostic module communicatively coupled to the misfire detection module, the ignition system diagnostic module including:
a statistical module configured to determine a percentage of the misfire cycles during the engine runtime; and
a control module operatively coupled to the statistical module and configured to perform at least one of:
changing an operational parameter of the engine system when the percentage of the misfire cycles is less than a pre-defined threshold value; and
providing a warning message indicating a required maintenance when the percentage of the misfire cycles is greater than the pre-defined threshold value.

2. The on board diagnostic system of claim 1, wherein the IMEP monitoring module is operatively connected to an in-cylinder pressure sensor and a crank angle encoder, the IMEP monitoring module being configured to monitor the IMEP based on an in-cylinder pressure received from the in-cylinder pressure sensor and a crank angle received from the crank angle encoder.

3. The on-board diagnostic system of claim 1 further comprises a heat release rate monitoring module configured to detect a heat release rate during the operation cycle of the cylinder.

4. The on-board diagnostic system of claim 3, wherein the heat release rate monitoring module is operatively connected to an in-cylinder pressure sensor and a crank angle encoder, the heat release rate monitoring module being configured to monitor the heat release rate based on an in-cylinder pressure received from the in-cylinder pressure sensor and a crank angle received from the crank angle encoder.

5. The on-board diagnostic system of claim 3, wherein the heat release rate is indicative of an amount of exhaust released per unit volume of fuel burnt in a combustion chamber during the operation cycle of the cylinder.

6. The on-board diagnostic system of claim 1, wherein the operational parameter includes at least one of an ignition timing, a fuel-air equivalence ratio, and fuel supply to the cylinder.

7. The on-board diagnostic system of claim 6, wherein the control module is configured to change the operational parameter of the engine system by performing at least one of:
changing the ignition timing;
shutting down the fuel supply; and
changing the fuel-air equivalence ratio.

8. The on-board diagnostic system of claim 1 further comprising an operator warning system communicatively coupled to the ignition system diagnostic module and configured to receive the warning message from the control module and provide the warning message by using at least one of a display device and an audio device.

9. A method for detecting a fault in an ignition system of an engine system, the engine system having a cylinder, the method comprising:
monitoring an indicated mean effective pressure (IMEP) indicative of an average pressure in the cylinder during an operation cycle of the cylinder during an engine runtime;
detecting misfire cycles associated with the cylinder based on the monitored IMEP during the engine runtime;
determining a percentage of the misfire cycles during the engine runtime; and
comparing the percentage of the misfire cycles with a pre-defined threshold value and performing at least one of:
changing an operational parameter of the engine system when the percentage of the misfire cycles is less than the pre-defined threshold value; and
providing a warning message indicating a required maintenance when the percentage of the misfire cycles is greater than the pre-defined threshold value.

10. The method of claim 9, wherein monitoring the IMEP further comprises:
detecting an in-cylinder pressure associated with the cylinder using in-cylinder pressure sensors; and
detecting a crank angle associated with the cylinder using a crank angle encoder.

11. The method of claim 9 further comprises monitoring a heat release rate indicative of an amount of exhaust released per unit volume of fuel burnt in a combustion chamber during the operation cycle of the cylinder.

12. The method of claim 11, wherein monitoring the heat release rate further comprises detecting an in-cylinder pressure and a crank angle associated with the cylinder.

13. The method of claim 9, wherein changing the operational parameter of the engine system comprises at least one of:
changing an ignition timing;
shutting down a fuel supply; and
changing a fuel-air equivalence ratio.

14. An engine system comprising:
a cylinder defining a combustion chamber;
an ignition system for igniting an air-fuel mixture in the combustion chamber;
an on-board diagnostic system for detecting a fault in the ignition system, the on-board diagnostic system including:
an indicated mean effective pressure (IMEP) monitoring module configured to monitor an indicated mean effective pressure (IMEP) indicative of an average pressure during an operation cycle of the cylinder during an engine runtime;
a misfire detection module configured to detect misfire cycles associated with the cylinder based on the monitored IMEP associated with the operation cycle of the cylinder during the engine runtime; and
an ignition system diagnostic module communicatively coupled to the misfire detection module, the ignition system diagnostic module including:
a statistical module configured to determine a percentage of the misfire cycles during the engine runtime; and
a control module operatively coupled to the statistical module and configured to perform at least one of:
changing an operational parameter of the engine system when the percentage of the misfire cycles is less than a pre-defined threshold value; and
providing a warning message indicating a required maintenance when the percentage of the misfire cycles is greater than the pre-defined threshold value.

15. The engine system of claim 14 further includes an in-cylinder pressure sensor to monitor an in-cylinder pressure associated with the cylinder and provide the monitored in-cylinder pressure to the IMEP monitoring module.

16. The engine system of claim 15, wherein the in-cylinder pressure sensor is a piezoelectric type sensor.

17. The engine system of claim 14 further includes a crank angle encoder configured to monitor a crank angle associated with the cylinder and provide the monitored crank angle to the IMEP monitoring module.

18. The engine system of claim 14, wherein the on-board diagnostic system includes a heat release rate monitoring module configured to monitor a heat release rate indicative of an amount of exhaust released per unit volume of fuel burnt in the combustion chamber during the operation cycle of the cylinder.

19. The engine system of claim 14, wherein the operational parameter includes at least one of an ignition timing, a fuel-air equivalence ratio, and fuel supply to the cylinder.

20. The engine system of claim 19, wherein the control module is configured to change the operational parameter of the engine system by performing at least one of:
changing the ignition timing;
shutting down the fuel supply; and
changing the fuel-air equivalence ratio.
